(19) United States
(12) Patent Application Publication
(10) Pub. No.: US 2009/0226766 A1
(43) Pub. Date: Sep. 10, 2009

(54) STAMPER FOR TRANSFERRING PATTERN, METHOD FOR MANUFACTURING MAGNETIC RECORDING MEDIUM BY USING THE STAMPER, AND THE MAGNETIC RECORDING MEDIUM

(75) Inventors: Mineo Moribe, Kawasaki (JP); Takahiro Umada, Kawasaki (JP); Yasuo Hosoda, Tsurugashima-shi (JP); Kazunobu Hashimoto, Tsurugashima-shi (JP)

Correspondence Address: GREER, BURNS & CRAIN, 300 S WACKER DR, 25TH FLOOR, CHICAGO, IL, 60606, US

(73) Assignees: FUJITSU LIMITED, Kawasaki-shi (JP); PIONEER CORPORATION, Tokyo (JP)

(21) Appl. No.: 12/425,971

(22) Filed: Apr. 17, 2009

Related U.S. Application Data
(63) Continuation of application No. PCT/JP2006/320936, filed on Oct. 20, 2006.

(51) Int. Cl. G11B 5/84; G11B 5/82; B29C 59/00

(52) U.S. Cl. 428/848; 216/22; 425/470

(57) ABSTRACT

A pattern transfer stamper 1 according to the present invention transfers an uneven pattern to a deformable surface of a member which is a base for manufacturing a magnetic disc D including a data region 81 and a servo region 82 positioned adjacent to the data region 81 in the circumferential direction. The pattern transfer stamper 1 includes at least a guard band pattern portion 11 corresponding to the data region 81. The guard band pattern portion 11 includes linear projections 11a extending in the circumferential direction and spaced from each other in the radial direction. A support projection 15 for supporting ends 11b of the linear projections 11a is provided to be integrally connected to the ends.

This application is a U.S. Continuation of International Application Serial No. PCT/JP2006/320936, filed Oct. 20, 2006.

### TECHNICAL FIELD

The present invention relates to a pattern transfer stamper for transferring a fine uneven pattern onto a magnetic disc in manufacturing a magnetic recording medium (e.g. magnetic disc). The invention also relates to a method for manufacturing a magnetic recording medium using a pattern transfer stamper, and a magnetic recording medium.

### BACKGROUND ART

For instance, as depicted in FIG. 15, the surface of a magnetic disc has a data region 81 and a servo region 82. The data region 81 is provided with a plurality of concentric tracks (not illustrated). The data region 81 is further provided with a plurality of guard bands (not illustrated) extending in the circumferential direction of the magnetic disc D. The guard bands serve to separate the tracks from each other. The servo region 82 is provided adjacent to the data region 81 in the circumferential direction. The servo region 82 is utilized for detecting each track. The servo region 82 is provided with a servo pattern which represents servo information such as positional information of each track.

As a method for manufacturing a magnetic disc D of a high density, a transferring method called nanoimprinting has been proposed as disclosed in e.g. Patent Document 1. The nanoimprinting is a technique to transfer an uneven pattern to the surface of a resin layer formed on a substrate which is a base. The uneven pattern is formed by pressing a pattern transfer stamper (hereinafter simply referred to as “stamper”) against the resin layer. The surface of the stamper is formed with fine projections or recesses in units of nanometers. The uneven pattern represents e.g. tracks or servo patterns.

Patent Document 1: Japanese Lain-open Patent Publication No. 2005-286222

FIG. 16 is a perspective view depicting a principal portion of a conventional stamper. The stamper 86 has an uneven surface 87 including a guard band pattern portion 88 and a servo pattern portion 89. The guard band pattern portion 88 corresponds to the data region 81 of the magnetic disc D. The servo pattern portion 89 corresponds to the servo region 82 of the magnetic disc D.

The guard band pattern portion 88A includes a plurality of linear projections 90 extending in the circumferential direction. The linear projections 90 serve to form guard bands on the surface of the magnetic disc D. The servo pattern portion 89 includes square projections 91 projecting to be substantially rectangular. The square projections 91 form a servo burst portion representing e.g. positional information. In the stamper 86 depicted in FIG. 16, the linear projections 90 and the square projections 91 are spaced from each other by a predetermined distance.

To manufacture the magnetic disc D by nanoimprinting, the stamper 86 depicted in FIG. 16 is pressed against a resin layer of the magnetic disc D. Since the linear projections 90 and the square projections 91 are spaced from each other, the pressure in the pressing concentrates on the ends 90a and the nearby portion of the linear projections 90. Thus, when the stamper 86 is repetitively used for manufacturing magnetic discs D, the ends 90a of the linear projections 90 may be deformed to be bent in the radial direction, as depicted in FIG. 17. Depending on the use conditions, the ends 90a of the linear projections 90 may be damaged or broken.

When the stamper 86 having the shape depicted in FIG. 17 is pressed against the resin layer of the magnetic disc D, offset occurs at the guard bands corresponding to the linear projections 90 and the adjacent tracks. Thus, it is difficult to accurately transfer a proper uneven pattern. As a result, the data magnetized in the tracks cannot be read properly, and the quality of data signals is deteriorated. Moreover, when the stamper 86 depicted in FIG. 17 is used repetitively, the margin for the offset of tracks is reduced. As a result, the read/write margin of the entire magnetic disc D is reduced, which has a bad influence on the use of the magnetic disc D.

### DISCLOSURE OF THE INVENTION

The present invention has been proposed under the circumstances described above. Therefore, an object of the present invention is to provide a pattern transfer stamper capable of transferring an uneven pattern properly and precisely. Another object of the present invention is to provide a method for manufacturing a magnetic recording medium using the pattern transfer stamper. Still another object of the present invention is to provide a magnetic recording medium manufactured by the manufacturing method.

According to a first aspect of the present invention, there is provided a pattern transfer stamper for transferring an uneven pattern to a deformable surface of a member which is a base for manufacturing a disc-shaped magnetic recording medium. The magnetic recording medium includes a data region and a servo region positioned adjacent to the data region in a circumferential direction. The pattern transfer stamper includes at least a data-region-corresponding uneven pattern portion corresponding to the data region of the disc-shaped magnetic recording medium. The data-region-corresponding uneven pattern portion includes linear projections extending in the circumferential direction and spaced from each other in a radial direction. A support projection for supporting an end of at least one of the linear projections is provided to be integrally connected to the end.

Preferably, the support projection extends in the radial direction and is connected to the ends of the plurality of linear projections.

Preferably, the support projection has a width which is larger than the width of the linear projections.

Preferably, the pattern transfer stamper further includes a servo-region-corresponding uneven pattern portion corresponding to the servo region of the disc-shaped magnetic recording medium. The servo-region-corresponding uneven pattern portion includes a plurality of servo-region-corresponding linear projections extending in the radial direction and spaced from each other in the circumferential direction. Of the plurality of servo-region-corresponding linear projections, the servo-region-corresponding linear projection positioned adjacent to the data-region-corresponding uneven pattern portion serves as the support projection.

Preferably, the support projection has a substantially square shape and is connected to the ends of at least two of the linear projections.

Preferably, the support projection has a substantially square shape and is connected to the end of every other linear projection.

Preferably, the pattern transfer stamper further includes a servo-region-corresponding uneven pattern portion corresponding to the servo region of the disc-shaped magnetic recording medium. The servo-region-corresponding uneven pattern portion includes a plurality of rectangular projections having a substantially rectangular shape. Of the plurality of rectangular projections, the rectangular projection positioned adjacent to the data-region-corresponding uneven pattern portion serves as the support projection.

Preferably, the support projection extends obliquely with respect to the radial direction and is connected to the ends of at least two of the linear projections.

Preferably, the pattern transfer stamper further includes a servo-region-corresponding uneven pattern portion corresponding to the servo region of the disc-shaped magnetic recording medium. The servo-region-corresponding uneven pattern portion includes a plurality of servo-region-corresponding linear projections extending obliquely with respect to the radial direction. Of the plurality of servo-region-corresponding linear projections, the servo-region-corresponding linear projection positioned adjacent to the data-region-corresponding uneven pattern portion serves as the support projection.

According to a second aspect of the present invention, there is provided a method for manufacturing a magnetic recording medium. The manufacturing method includes the steps of forming a magnetic layer on a substrate which is a base of the disc-shaped magnetic recording medium, forming a resin layer on the magnetic layer, and forming an uneven pattern by transferring an uneven pattern of the pattern transfer stamper provided according to the first aspect of the present invention onto the resin layer by pressing the uneven surface of the pattern transfer stamper against the resin layer and etching the exposed magnetic layer using the resin layer on the magnetic layer as a mask.

According to a third aspect of the present invention, there is provided a method for manufacturing a magnetic recording medium. The method includes the steps of transferring an uneven pattern of the pattern transfer stamper provided according to the first aspect of the present invention onto a deformable substrate which is a base of the disc-shaped magnetic recording medium by pressing the uneven surface of the pattern transfer stamper against the substrate, and forming a pattern of presence/absence of a magnetic member by forming a magnetic layer in recesses of the uneven pattern.

According to a fourth aspect of the present invention, there is provided a magnetic recording medium manufactured by the method provided according to the second or the third aspect of the present invention.

### BRIEF DESCRIPTION OF THE DRAWINGS

FIG. 1 is a perspective view depicting a principal portion of a pattern transfer stamper according to a first embodiment of the present invention.

FIG. 2 depicts the surface of a magnetic disc.

FIG. 3 depicts the surface configuration of a magnetic disc after being pressed by a pattern transfer stamper.

FIG. 4 depicts the structure of a pattern transfer apparatus.

FIG. 5 depicts steps of a method for manufacturing a magnetic disc.

FIG. 6 depicts steps of the method for manufacturing a magnetic disc.

FIG. 7 depicts steps of another method for manufacturing a magnetic disc.

FIG. 8 depicts steps of the method for manufacturing a magnetic disc.

FIG. 9 is a perspective view depicting a principal portion of a pattern transfer stamper according to a second embodiment of the present invention.

FIG. 10 is a perspective view depicting a principal portion of a pattern transfer stamper according to a third embodiment of the present invention.

FIG. 11 is a perspective view depicting a principal portion of a pattern transfer stamper according to a fourth embodiment of the present invention.

FIG. 12 is a perspective view depicting a principal portion of a pattern transfer stamper according to a fifth embodiment of the present invention.

FIG. 13 is a perspective view depicting a principal portion of a pattern transfer stamper according to a sixth embodiment of the present invention.

FIG. 14 is a perspective view depicting a principal portion of a pattern transfer stamper according to a seventh embodiment of the present invention.

FIG. 15 depicts the appearance of a magnetic disc.

FIG. 16 is a perspective view depicting a principal portion of a conventional pattern transfer stamper.

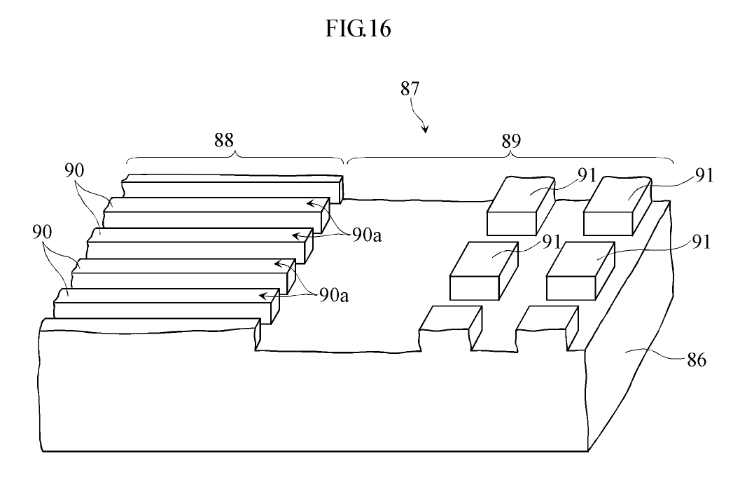

FIG. 17 is a perspective view depicting a principal portion of a conventional pattern transfer stamper.

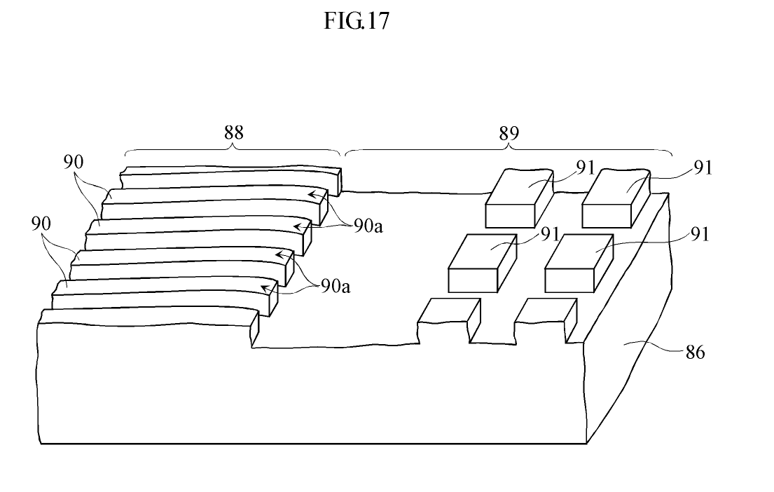

### BEST MODE FOR CARRYING OUT THE INVENTION

Preferred embodiments of the present invention will be described below with reference to the accompanying drawings.

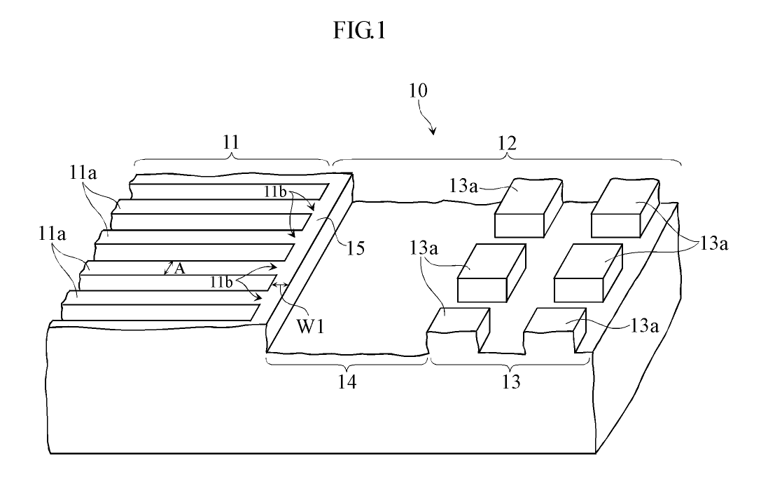

FIG. 1 is a perspective view depicting a principal portion of a stamper for transferring a pattern according to a first embodiment of the present invention. The pattern transfer stamper 1 (hereinafter simply referred to as “stamper 1”) is used in manufacturing a magnetic disc D as a magnetic recording medium. For instance, the magnetic disc D is called a discrete track media. The stamper 1 is used for transferring a fine uneven pattern onto a magnetic disc D by nanoimprinting.

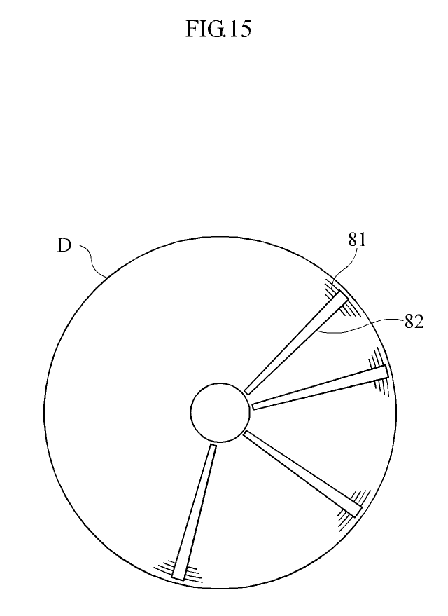

As depicted in FIG. 15, which has been referred to for describing the background art, the magnetic disc D has a rounded shape. At least one surface of the magnetic disc D includes a data region 81 and a servo region 82.

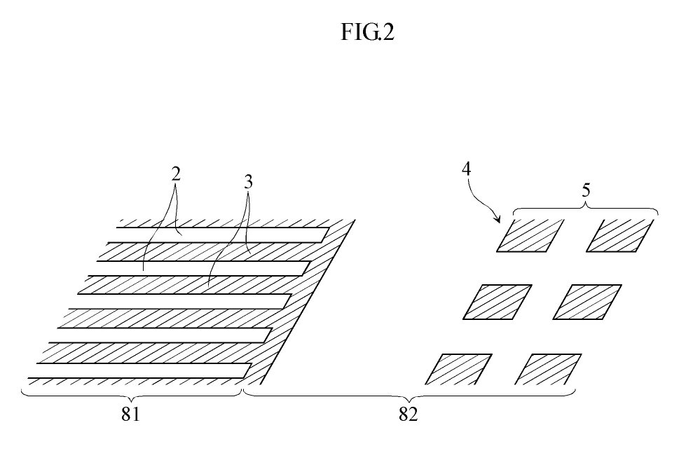

FIG. 2 is a perspective view depicting the data region 81 and the servo region 82 of the magnetic disc D. The data region 81 is formed with a plurality of concentric tracks 2. The data region 81 is further formed with a plurality of guard bands 3 (see circumferential, hatched portions) extending in the circumferential direction of the magnetic disc D. The guard bands 3 serve to separate the tracks 2 from each other. As will be described later, the tracks 2 may be made of e.g. a magnetic material, whereas the guard bands 3 may be made of e.g. a nonmagnetic material.

The servo region 82 is provided adjacent to the data region 81 in the circumferential direction. The servo region 82 is utilized for detecting tracks 2. The servo region 82 is formed with a servo pattern 4. The servo pattern 4 represents servo information such as positional information of the tracks 2. FIG. 2 depicts a servo burst portion 5 which constitutes part of the servo pattern 4. The servo burst portion 5 is used for the tracking of a non-illustrated magnetic head.

The tacks 3 and the servo pattern 4 are formed by transferring an uneven pattern by the stamper 1. Specifically, to manufacture the magnetic disc D, the stamper 1 is pressed against the base member (e.g. a resin layer) of the magnetic disc D. By this operation, a fine uneven pattern corresponding to the tracks 3 and the servo pattern 4 is transferred onto the resin layer. For this purpose, the stamper 1 has an uneven surface 10 (see FIG. 1) corresponding to the uneven pattern for the tracks 3 and the servo pattern 4.

The tracks 3 and the servo pattern 4 can be formed individually. Thus, the stamper 1 may have only the projection or recesses corresponding to the uneven pattern of the track 3 and may not have the projections or recesses corresponding to the uneven pattern of the servo pattern 4. That is, a stamper having only the projections or recesses corresponding to the uneven pattern of the tracks 3 is used to transfer the uneven pattern of the tracks 3. Then, another stamper having only the projections or recesses corresponding to the uneven pattern of the servo pattern 4 is used to transfer the uneven pattern of the servo pattern 4. In this case, the servo pattern 4 may be later formed on the magnetic disc D by a technique other than nanoimprinting. For instance, the servo pattern may be magnetically formed using a servo track writer.

The stamper 1 may include e.g. an Ni substrate or an SiO₂ substrate. The uneven surface 10 of the stamper 1 has substantially the same size as that of the disc surface of the magnetic disc D. The stamper 1 is formed by performing application of a resist, light exposure by electronic beams, development and plating or etching with respect to a surface of a material substrate.

Preferably, as depicted in FIG. 1, the uneven surface 10 of the stamper 1 is provided with a guard band pattern portion 11 and a servo pattern portion 12. The guard band pattern portion 11 corresponds to the data region 81 of the magnetic disc D and is formed with an uneven pattern in the radial direction. Specifically, a plurality of linear projections 11a extending in the circumferential direction are formed in the guard band pattern portion 11. The linear projections 11a are arranged at predetermined intervals in the radial direction.

The servo pattern portion 12 is provided with an uneven pattern corresponding to the servo region 82 of the magnetic recording medium. As depicted in FIG. 1, the servo pattern portion 12 includes a servo burst pattern portion 13 and a non-patterned portion 14. The servo burst pattern portion 13 is provided with a plurality of square projections 13a projecting to have a substantially rectangular shape. The square projections 13a are arranged in rows and columns. The servo burst pattern portion 13 corresponds to the servo burst portion 5 (see FIG. 2) provided in the servo region 82 of the magnetic recording medium D. The non-patterned portion 14 is not provided with an uneven pattern and is flat.

A support projection 15 for supporting the ends 11b of the linear support projections 11a of the guard band pattern portion 11 is provided to be integrally connected to the ends. The support projection 15 extends in the radial direction. The support projection 15 is connected to an end 11b of each of the linear projections 11a. The width W1 of the support projection 15 is substantially equal to the width A of the linear projections 11a.

Though not illustrated in FIG. 1, in addition to the servo burst pattern portion 13, a preamble pattern portion (which will be described later) or the like is formed in the servo pattern portion 12. The preamble pattern portion is provided with a plurality of linear projections extending in the radial direction. A phase difference signal pattern portion (which will be described later) may be provided instead of the servo burst pattern portion 13. The phase difference signal pattern portion is provided with a plurality of linear projections extending obliquely with respect to the circumferential direction.

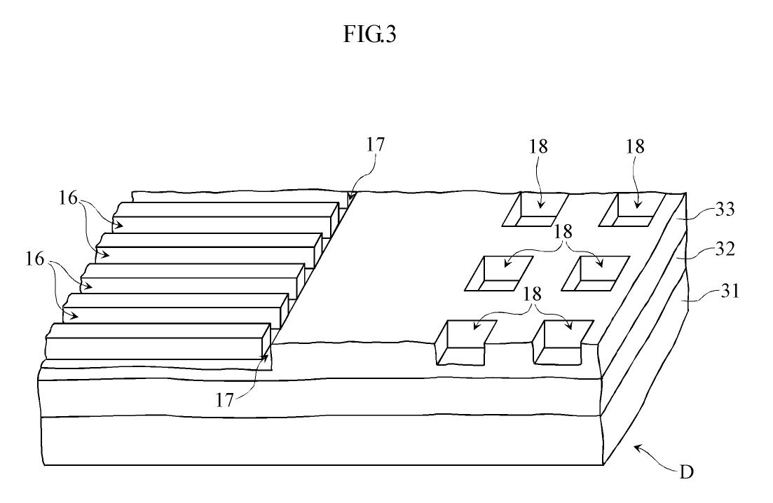

FIG. 3 is a perspective view depicting a principal portion of the surface of a base member of a magnetic recording medium D after being pressed by the stamper 1. As depicted in FIG. 3, the base member of the magnetic recording medium D includes a glass substrate 31, a magnetic film 32 and a resin layer 33. The magnetic film 32 is formed on the glass substrate 31. The resin layer 33 is formed on the magnetic film 32.

By the pressing with the stamper 1, the resin layer 33 is formed with a fine uneven pattern corresponding to the uneven surface 10 of the stamper. For instance, by the linear projections 11a of the stamper 1, a plurality of recesses 16 extending in the circumferential direction are formed at the surface of the resin layer 33. By the support projection 15 of the stamper 1, a recess 17 extending in the radial direction is formed at the surface of the resin layer 33. The recesses 16 communicate with each other via the recess 17. Further, by the square projections 13a of the stamper 1, a plurality of square recesses 18 formed on the surface of the resin layer 33.

As described above, according to the first embodiment, the support projection 15 is provided to be integrally connected to the ends 11b of the linear projections 11a, so that the linear projections 11a are connected to each other via the support projection 15. Thus, the ends 11b of the linear projections 11a are supported by the support projection 15, so that the ends 11b and the nearby portion are rigid. Thus, even when the stamper 1 is repetitively used in nanoimprinting, the ends 11b of the linear projections 11a are prevented from being deformed to be bent in the radial direction, damaged or broken.

Therefore, according to the first embodiment, the provision of the support projection 15 in the stamper 1 ensures that recesses 16 having a proper shape are formed in the resin layer 33. Thus, the uneven pattern is transferred properly and precisely. As will be described later, the resin layer 33 is used as a mask for etching. Owing to the provision of the recesses 16, the etching is performed precisely, so that tracks 2 are formed properly.

It is to be noted that the width W1 of the support projection 15 may be larger than the width A of the linear projections 11a. With this arrangement, the support projection 15 supports the ends 11b of the linear projections 11a more firmly. Alternatively, the width W1 of the support projection 15 may be smaller than the width A of the linear projections 11a if the support projection 15 can support the linear projections 11a.

To manufacture the magnetic disc D, the stamper 1 is pressed against the base member of the magnetic disc D, so that the pressure concentrates in the radial direction of the stamper 1. The support projection 15 and the linear projections 11a support each other. When the width W1 of the support projection 15 is small, the area occupied by the support projection 15 on the magnetic disc D is small, so that the density of the magnetic disc D can be increased. For these reasons, when the support projection 15 is provided individually on the stamper 1, it is preferable that the width W1 of the support projection 15 is smaller than the width A of the linear projections 11a.

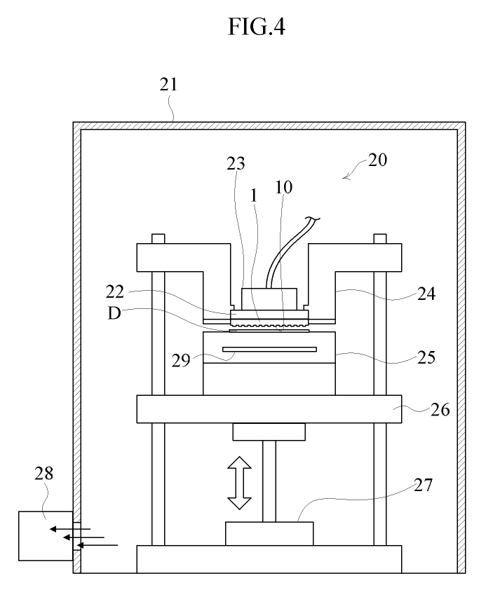

A method for manufacturing a magnetic disc D using the stamper 1 will be described below. In manufacturing a magnetic disc D, e.g. a pattern transfer apparatus 20 as depicted in FIG. 4 is used for transferring an uneven pattern by nanoimprinting using the stamper 1.

For instance, the pattern transfer apparatus 20 is set in a working chamber 21. The pattern transfer apparatus 20 includes the stamper 1, an upper holder 24, a lower panel 25, a lower elevating member 26 and a drive motor 27. The upper holder 24 holds the stamper 1 and the upper panel 22 horizontally. The upper holder further holds an upper unit 23. The lower panel 25 holds the upper holder 24 and the magnetic disc D horizontally. The lower elevating member 26 moves vertically while holding the lower panel 25. The drive motor 27 causes the vertical movement of the lower elevating member 26. In the working chamber 21, a vacuum pump for reducing the pressure in the working chamber 21 is provided. For instance, the vacuum pump 28 has the ability to reduce the pressure in the working chamber 21 to about 1 Torr.

The upper panel 22 is made of e.g. quartz glass and transmits the light for positioning. The upper unit 23 incorporates a mechanism (e.g. an illuminator or a photodetector) (not illustrated) for properly positioning the stamper 1 relative to the magnetic disc D within a horizontal plane. Thus, it is preferable that the stamper 1 is made of an SiO₂ substrate which transmits light.

The lower panel 25 incorporates a heater 29 for heating the stamper 1 and the magnetic disc D in contact with these. A heater for heating the stamper 1 and the magnetic disc D may be provided in the upper panel 25. When the lower elevating member 26 is moved vertically by the drive motor 27, the lower panel 25 moves vertically along with the elevating member. As a result, the magnetic disc D held horizontally by the lower panel 25 moves toward or away from the stamper 1 held at a predetermined height from the floor. In the state in which the magnetic disc is held in close contact with the uneven surface 10 of the stamper 1, the stamper 1 and the magnetic disc D are pressed against each other.

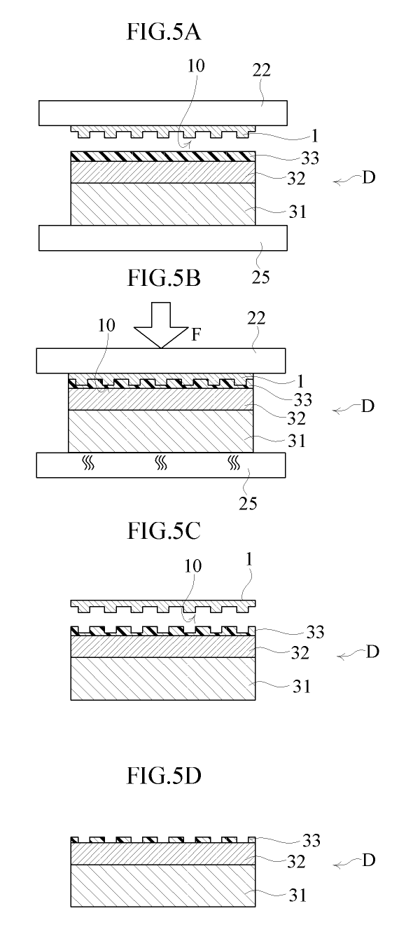

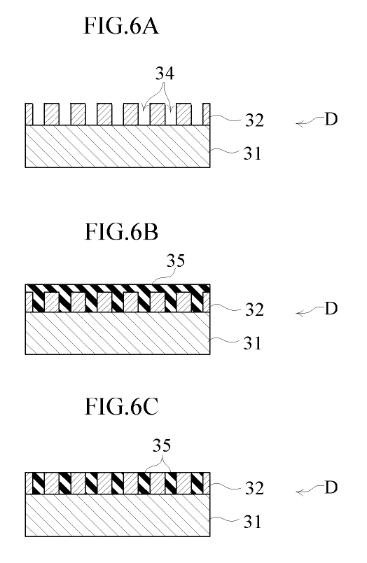

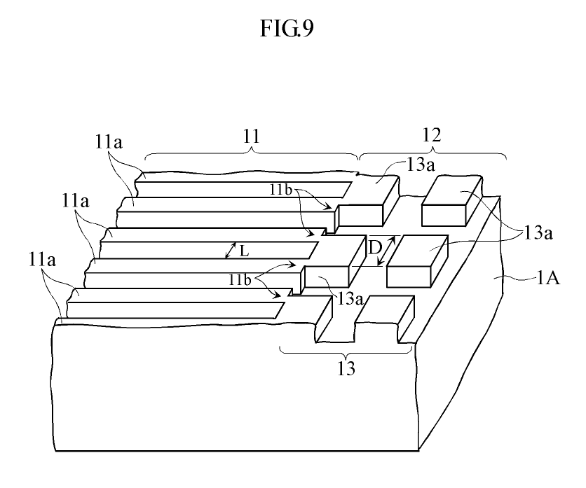

FIGS. 5 and 6 depict a manufacturing process of the magnetic disc D. In FIGS. 5 and 6, the uneven patterns of the stamper 1 and the magnetic disc D are enlarged to be clearer. Actually, however, the magnetic disc D of the size depicted in FIG. 9 is mounted.

First, in the manufacturing process, a base member of the magnetic disc D as depicted in FIG. 5A is prepared. For instance, the base member includes a glass substrate 31, a magnetic film 32 formed on a surface of the glass substrate 31, and a resin layer 33 formed on the magnetic film 32. In the manufacturing process, the resin layer 33 is to be used as a mask (which will be described later). The resin layer 33 is formed by e.g. spin coating. The resin layer 33 is made of e.g. a thermoplastic resin such as polymethyl methacrylate resin (PMMA). The glass transition point of the resin layer 33 is about 100° C.

As depicted in FIG. 5A, the uneven surface 10 of the stamper 1 is brought into close contact with the surface of the resin layer 33. In bringing the uneven surface 10 of the stamper 1 into close contact with the resin layer 33, the vacuum pump 28 (not illustrated in the figure) is actuated. As a result, the working chamber 21 is held in vacuum of about 1 Torr.

Then, under the vacuum condition, pressure application and heating are performed with respect to the uneven surface 10 of the stamper 1 and the resin layer 33. Specifically, as depicted in FIG. 5B, with the press surface 10 and the resin layer 33 held in contact with each other, the stamper 1 and the magnetic disc D are sandwiched between the upper panel 22 and the lower panel 25. The stamper 1 and the magnetic disc D are pressed by the upper panel 22 and the lower panel 25 with a pressing force F of e.g. about 2500 kgf. The stamper 1 and the magnetic disc D are heated by the heater 29 to about 135° C., which is higher than the glass transition point of the resin layer 33.

Then, after the lapse of a predetermined cooling period, the vacuum of the working chamber 21 is eliminated. Then, as depicted in FIG. 5C, the uneven surface 10 of the stamper 1 is separated from the resin layer 33. Thus, the resin layer 33, on which the uneven pattern corresponding to the uneven surface 10 is transferred and which is hardened, is obtained. The uneven pattern of the resin layer 3 is used as a mask for etching, which will be described later.

In this way, the uneven pattern corresponding to the uneven surface 10 of the stamper 1 is transferred onto the resin layer 33. As noted before, the stamper is formed with the support projection 15 connected to the ends 11b of the linear projections 11a. Thus, even when the stamper 1 is repetitively used, the ends 11b of the linear projections 11a are prevented to be bent. Thus, the uneven pattern corresponding to the uneven surface 10 is formed on the resin layer 33 without a transfer defect. Thus, the fine uneven pattern is properly transferred onto the resin layer 33.

After the uneven pattern is transferred, portions of the resin layer 33 which are not necessary as a mask remain. As depicted in FIG. 5D, such residual portions of the resin layer 33 are removed. As a result, the magnetic film 32 is exposed at the bottom of the recesses of the resin layer 33.

Then, etching is performed with respect to the magnetic film 32 using the resin layer 33 as a mask. As depicted in FIG. 6A, by subsequently removing the resin layer 33, recesses 34 are formed in the magnetic film 32.

Thereafter, as depicted in FIG. 6B, a non-magnetic material 35 is fixed to the magnetic film 32 to fill the recesses 34. Then, as depicted in FIG. 6C, the surfaces of the magnetic film 32 and the non-magnetic material 35 are ground. Thus, the magnetic film 32 is divided into portions separated by the non-magnetic film 35 filling the recesses 34. Further, on these surfaces, a protective film or a lubricating film (both not illustrated) may be formed. In this way, the magnetic disc D as a discrete track media is completed.

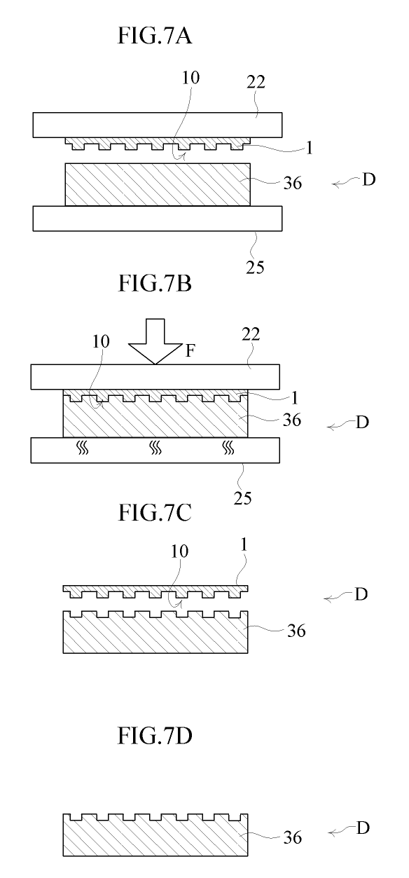

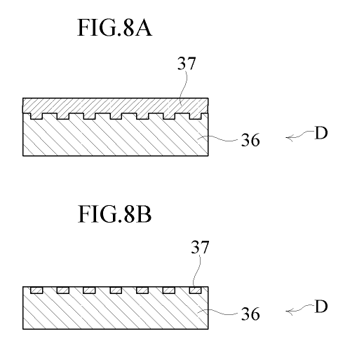

FIGS. 7 and 8 depict another method for manufacturing the magnetic disc D. In FIGS. 7 and 8, the uneven patterns of the stamper 1 and the magnetic disc D are enlarged to be clearer. Actually, however, the magnetic disc D of the size depicted in FIG. 9 is mounted. This manufacturing method differs from the above-described manufacturing method in that a resin substrate 36 is used instead of the glass substrate 31. Further, unlike the above-described manufacturing method in which the magnetic film 32 is formed on the glass substrate 31 in advance, the magnetic film 32 is formed after the pressing with the resin stamper 1 is performed in this method.

First, in this manufacturing process, a deformable resin substrate 36 is prepared as the base member of the magnetic disc D. As depicted in FIG. 7A, after a vacuum is produced in the vacuum chamber 21, the uneven surface 10 of the stamper 1 is directly brought into close contact with the surface of the resin substrate 36.

Then, under the vacuum condition, pressure application and heating are performed with respect to the uneven surface 10 and the resin layer 36. Specifically, as depicted in FIG. 7B, with the uneven surface 10 and the resin substrate 36 held in contact with each other, the stamper 1 and the resin substrate 36 are sandwiched between the upper panel 22 and the lower panel 25. The stamper 1 and the resin substrate 36 are pressed with a pressing force F. Then, the stamper 1 and the resin substrate 36 are heated by the heater 29.

Then, after the lapse of a predetermined cooling period, the vacuum of the working chamber 21 is eliminated. Then, as depicted in FIG. 7C, the uneven surface 10 of the stamper 1 is separated from the resin substrate 36. Thus, as depicted in FIG. 7D, the resin substrate 36, on which the uneven pattern corresponding to the uneven surface 10 is transferred and which is hardened, is obtained.

Thereafter, as depicted in FIG. 8A, a magnetic film 37 is fixed to entirely cover the resin substrate 36. Then, as depicted in FIG. 8B, the surface of the magnetic film 37 is ground, so that the magnetic film 37 is separated from the resin substrate 36 on the surface of the base member. In this way, the magnetic disc D as a discrete track media is completed.

FIGS. 9-14 depicts a second through a seventh embodiments of the present invention. These embodiments are variations of the support projection 15 of the first embodiment. That is, these embodiments teach other structures for supporting the ends 11b of the linear projections 11a of the guard band pattern portion 11.

FIG. 9 is a perspective view depicting a principal portion of a stamper according to the second embodiment of the present invention. In this stamper 1A, the square projections 13a of the servo burst pattern portion 13 are utilized instead of the support projection 15 of the first embodiment.

Each of the square projections 13a is integrally connected to the ends 11b of two adjacent linear projections 11a of the guard band pattern portion 11. Of the square projections 13a of the servo burst pattern portion 13, those formed adjacent to the guard band pattern 11 are connected to the linear projections 11a.

The length D of each side of the square projection 13a is larger than the distance L between two adjacent linear projections 11a so that the square projection 13a is connected to the ends 11b of the two adjacent linear projections 11a. In this way, in the second embodiment, the non-patterned portion 14 of the first embodiment (see FIG. 1) is eliminated so that the guard band pattern portion 11 and the servo burst pattern portion 13 are arranged adjacent to each other.

In the second embodiment, the square projection 13a serving as a support member connects the ends 11b of two adjacent linear projections 11a to each other. Thus, the ends 11b of the two adjacent linear projections 11a are supported to be rigid. Alternatively, the square projection 13a may be arranged to connect the ends 11b of three or more linear projections 11a to each other.

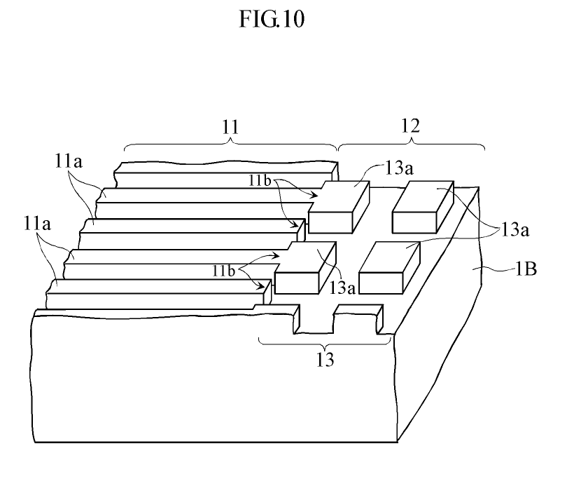

FIG. 10 is a perspective view depicting a principal portion of a stamper according to the third embodiment of the present invention. The stamper 1B of this embodiment differs from that of the second embodiment in that a square projection 13a illustrated in the second embodiment (see FIG. 9) is integrally connected to the end 11b of every other linear projection 11a.

Although the ends 11b of two linear projections 11a are not connected to each other in the arrangement of the third embodiment, the end 11b of every other linear projection 11a and the nearby portion can be made rigid.

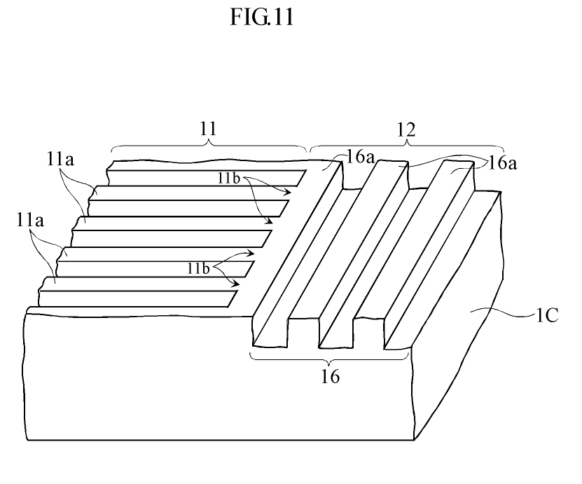

FIG. 11 is a perspective view depicting a principal portion of a stamper according to the fourth embodiment of the present invention. In this stamper 1C, linear projections 16a of the preamble pattern portion 16 are utilized instead of the support projection 15 of the first embodiment.

The preamble pattern portion 16 is formed in the servo pattern portion 12 and corresponds to a preamble portion (not illustrated) in the servo region 82 of the magnetic disc D. The preamble portion represents clock information for reading the data of the tracks 2. The preamble pattern portion 16 is formed with a plurality of linear projections 16a extending in the radial direction.

In the fourth embodiment, of the linear projections 16a of the preamble pattern 16, the one arranged adjacent to the guard band pattern portion 11 is connected to the ends 11b of the linear projections 11a of the guard band pattern portion 11. Thus, the ends 11b of the linear projections 11a are supported to be rigid.

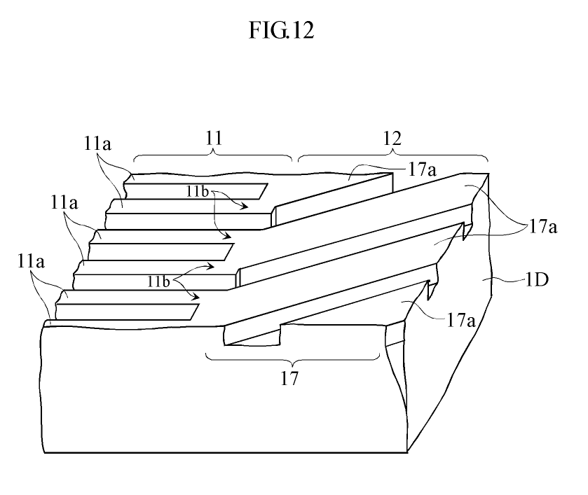

FIG. 12 is a perspective view depicting a principal portion of a stamper according to the fifth embodiment of the present invention. In this stamper 1D, linear projections 17a of a phase difference signal pattern portion 17 are utilized instead of the support projection 15 of the first embodiment.

The phase difference signal pattern portion 17 is formed in the servo pattern portion 12 and corresponds to a phase difference signal portion (not illustrated) in the servo region 82 of the magnetic disc D. The phase difference signal portion represents positional information or sector information. The phase difference signal pattern portion 17 is provided with a plurality of linear projections 17a extending obliquely with respect to the circumferential direction.

In the fifth embodiment, the linear projections 17a are so formed that an end of each linear projection 17a connects the ends 11b of two adjacent linear projections 11a of the guard band pattern portion 11 to each other. That is, of the linear projections 17a of the phase difference signal pattern portion 17, the ends of the linear projections 17a which are adjacent to the guard band pattern portion 11 are connected to the linear projections 11a. With this arrangement, the ends 11b of adjacent two linear projections 11a are supported to be rigid by the linear projection 17a. Alternatively, the linear projection 17a may be arranged to connect the ends 11b of three or more linear projections 11a to each other.

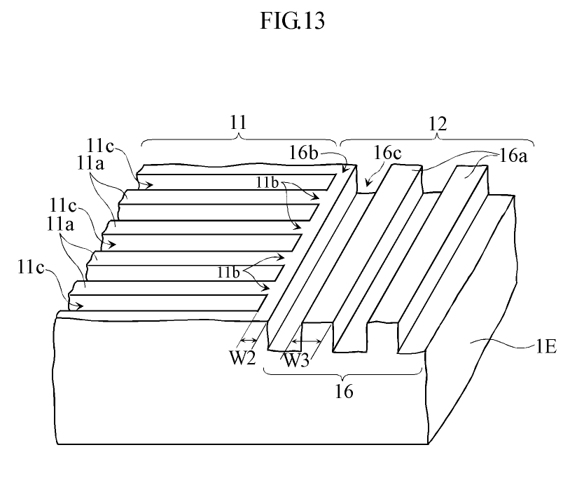

FIG. 13 is a perspective view depicting a principal portion of a stamper according to the sixth embodiment of the present invention. In this stamper 1E, a linear projection 16b of the preamble pattern portion 16 is utilized instead of the support projection 15 of the first embodiment. The linear projection 16b extends in the radial direction. The width W2 of the linear projection 16b is relatively small. Specifically, the width W2 of the linear projection 16b is smaller than the width W3 of linear projections 16a of the preamble pattern portion 16.

For instance, in the fourth embodiment (see FIG. 11) the linear projection 16a is integrally connected to the linear projections 11a of the guard pattern portion 11, so that the recess formed between the linear projections 11a are enclosed by the linear projection 16a. With this arrangement, when the stamper 1C (see FIG. 11) is pressed against the resin layer of the magnetic disc D, resin or air pushed out by the linear projection 16a integrally connected to the linear projections 11a cannot flow smoothly between the guard band pattern portion 11 and the servo pattern portion 12. As a result, excessive supply of resin due to the accumulation of resin or insufficient loading of resin due to the accumulation of air occurs, which hinders the formation of an uneven pattern having a proper configuration.

In the sixth embodiment, however, the width W2 of the linear projection 16b is made smaller than the width W3 of the linear projections 16a. With this arrangement, when the stamper 1E (see FIG. 13) is pressed against the resin layer of the magnetic disc D, only a small amount of resin flows into between the guard band pattern portion 11 (recesses 11c formed between the linear projections 11a) and the servo pattern portion 12 (recess 16c), and air flows smoothly. Thus, excessive supply or insufficient loading of resin is prevented, so that the performance of pattern transfer is not deteriorated.

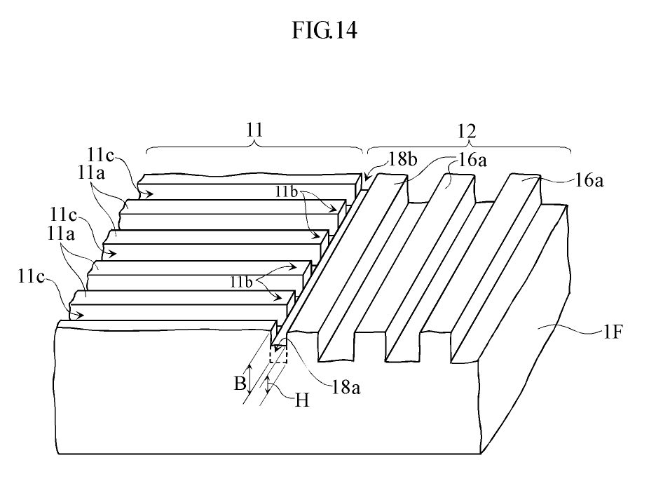

FIG. 14 is a perspective view depicting a principal portion of a stamper according to the seventh embodiment of the present invention. In this stamper 1F, a linear projection 18a is integrally connected to the ends 11b of the linear projections 11a of the guard band pattern portion 11. The linear projection 18a extends in the radial direction. The height H of the linear projection 18a is lower than the height B of the linear projections 11a.

Since the height of the linear projection 18a is lower than that of the linear projections 11a in the seventh embodiment, resin or air readily flows between the guard band pattern portion 11 (recesses 11c formed between the linear projections 11a) and the servo pattern portion 12 (recess 18b) when the stamper 1F (see FIG. 14) is pressed against the resin layer of the magnetic disc D. Thus, similarly to the sixth embodiment, insufficient loading of resin is prevented, so that the performance of pattern transfer is not deteriorated.

It is difficult to manufacture the stamper 1F of the seventh embodiment by a conventional etching technique, because the linear projection 18a and the linear projections 16a differ from each other in height. Preferably, therefore, the stamper 1F is manufactured by the method described below.

First, application of a resist, light exposure by electronic beams and development are performed with respect to a surface of a material substrate of the stamper 1F prepared in advance. A first etching step is performed using the applied resist as a mask. Then, resist is applied again. In this process, the recesses formed by the first etching process are filled with the resist applied later. Then, light exposure and development are performed. Then, a second etching step is performed on the conditions different from those of the first etching (e.g. different etching time) using the resist as a mask. By this process, a stepped portion is formed on the material substrate of the stamper 1F so that the linear projection 18a and the linear projections 16a having different heights are formed.

The present invention is not limited to the foregoing embodiments. For instance, the object to which the uneven pattern is to be transferred is not limited to a discrete track media. The present invention is also effective in making another stamper by transferring the uneven pattern of the stamper 1 by nanoimprinting. Further, in duplicating a stamper by a technique other than nanoimprinting, such as plating, a force opposite from that of nanoimprinting is applied to the stamper 1 in removing the duplicated stamper from the stamper 1. This causes the deformation or damage of the stamper similarly to the problem which the present invention aims to solve. Thus, the present invention is also effective for such duplication. The stamper 1 of the foregoing embodiments is applicable to other situations where a fine uneven pattern needs to be formed.

1. A pattern transfer stamper for transferring an uneven pattern to a deformable surface of a member which is a base for manufacturing a disc-shaped magnetic recording medium, the magnetic recording medium including a data region and a servo region positioned adjacent to the data region in a circumferential direction, the pattern transfer stamper comprising:
at least a data-region-corresponding uneven pattern portion corresponding to the data region of the disc-shaped magnetic recording medium;
wherein the data-region-corresponding uneven pattern portion includes linear projections extending in the circumferential direction and spaced from each other in a radial direction; and
wherein a support projection for supporting an end of at least one of the linear projections is provided to be integrally connected to the end.

2. The pattern transfer stamper according to claim 1, wherein the support projection extends in the radial direction and is connected to the ends of the plurality of linear projections.

3. The pattern transfer stamper according to claim 2, wherein the support projection has a width which is larger than a width of the linear projections.

4. The pattern transfer stamper according to claim 2, further comprising a servo-region-corresponding uneven pattern portion corresponding to the servo region of the disc-shaped magnetic recording medium;
wherein the servo-region-corresponding uneven pattern portion includes a plurality of servo-region-corresponding linear projections extending in the radial direction and spaced from each other in the circumferential direction; and
wherein, of the plurality of servo-region-corresponding linear projections, the servo-region-corresponding linear projection positioned adjacent to the data-region-corresponding uneven pattern portion serves as the support projection.

5. The pattern transfer stamper according to claim 1, wherein the support projection has a substantially square shape and is connected to the ends of at least two of the linear projections.

6. The pattern transfer stamper according to claim 1, wherein the support projection has a substantially square shape and is connected to the end of every other linear projection.

7. The pattern transfer stamper according to claim 5 or 6, further comprising a servo-region-corresponding uneven pattern portion corresponding to the servo region of the disc-shaped magnetic recording medium;
wherein the servo-region-corresponding uneven pattern portion includes a plurality of rectangular projections having a substantially rectangular shape; and
wherein, of the plurality of rectangular projections, the rectangular projection positioned adjacent to the data-region-corresponding uneven pattern portion serves as the support projection.

8. The pattern transfer stamper according to claim 1, wherein the support projection extends obliquely with respect to the radial direction and is connected to the ends of at least two of the linear projections.

9. The pattern transfer stamper according to claim 8, further comprising a servo-region-corresponding uneven pattern portion corresponding to the servo region of the disc-shaped magnetic recording medium;
wherein the servo-region-corresponding uneven pattern portion includes a plurality of servo-region-corresponding linear projections extending obliquely with respect to the radial direction; and
wherein, of the plurality of servo-region-corresponding linear projections, the servo-region-corresponding linear projection positioned adjacent to the data-region-corresponding uneven pattern portion serves as the support projection.

10. A method for manufacturing a magnetic recording medium, the method comprising the steps of forming a magnetic layer on a substrate which is a base of the disc-shaped magnetic recording medium, forming a resin layer on the magnetic layer, and forming an uneven pattern by transferring an uneven pattern of the pattern transfer stamper as set forth in claim 1 onto the resin layer by pressing the uneven surface of the pattern transfer stamper against the resin layer and etching the exposed magnetic layer using the resin layer on the magnetic layer as a mask.

11. A method for manufacturing a magnetic recording medium, the method comprising the steps of transferring an uneven pattern of the pattern transfer stamper as set forth in claim 1 onto a deformable substrate which is a base of the disc-shaped magnetic recording medium by pressing the uneven surface of the pattern transfer stamper against the substrate, and forming a pattern of presence/absence of a magnetic member by forming a magnetic layer in recesses of the uneven pattern.

12. A magnetic recording medium manufactured by a method as set forth in claim 10 or 11.
